(19) United States
(12) Patent Application Publication
(10) Pub. No.: US 2026/0029595 A1
(43) Pub. Date: Jan. 29, 2026

(54) Light Modulation Device

(71) Applicant: Nippon Telegraph and Telephone Corporation, Tokyo (JP)

(72) Inventors: Yoshihiro Ogiso, Musashino-shi, Tokyo (JP); Mitsuteru Ishikawa, Musashino-shi, Tokyo (JP); Josuke Ozaki, Musashino-shi, Tokyo (JP)

(21) Appl. No.: 18/995,456

(22) PCT Filed: Aug. 8, 2022
(86) PCT No.: PCT/JP2022/030301

§ 371 Date: Jan. 16, 2025

(51) Int. Cl. G02B 6/42

(52) U.S. Cl. CPC G02B 6/4271; G02B 6/4238; G02B 6/4239; G02B 6/4244

(57) ABSTRACT

An object of the present invention is to provide a light modulation device capable of preventing deformation of an optical modulation element due to warpage of a TEC. The light modulation device of the present invention includes an optical modulation element that is flip-chip connected on a high-frequency wiring substrate, a temperature controller that controls a temperature of the optical modulation element, a heat spreader that is connected to the temperature controller, and a deformable adhesive layer that connects the temperature controller and the optical modulation element on a surface different from the heat spreader and is deformable in response to stress caused by deformation of the temperature controller

### TECHNICAL FIELD

The present invention relates to a light modulation device which functions as a high-speed optical modulator in the field of optical communication.

### BACKGROUND ART

As the optical fiber communication is made faster and larger in capacity, the speed of an optical modulator for converting an electric signal into an optical signal has also accelerated. Here, a major problem for realizing the high speed is that the electro-optic component itself is made to be high-speed (broadband) and that the high-frequency mounting is made to be high-speed (broadband). Particularly, as to the latter, in recent years, a flip chip mounting technique with a lower inductance component has been attracting attention as an alternative to a gold wire bonding technique which has been conventionally used for high-frequency connection between electro-optical components (PTL 1).

Among optical modulation element materials, in an optical modulator using silicon photonics which has been attracting attention recently, a driver IC and an optical modulator chip are flip-chip connected on a high-frequency wiring substrate to minimize a discontinuous region (reflection point) seen from a high frequency, thereby allowing a broadband electrical signal to be fed to the optical modulation element with a lower reflection. However, in the mounting technique, due to the property of mounting the light modulation element on the same substrate as the driver IC which generates heat, it is difficult to adopt the mounting method except for an optical modulation element which can guarantee a stable operation against heat radiation from the driver IC. That is, while the above-mentioned technique is applicable to a silicon-based modulator having a small temperature dependency, a large problem is that a modulation characteristic of an InP-based modulator having a large temperature dependency varies due to flip-chip mounting. In the InP optical modulation element, the band edge absorption wavelength fluctuates with temperature, resulting in the modulation characteristics being significantly affected by the environmental temperature in the communication wavelength band.

Thus, in the optical modulation device using the flip chip, the mainstream is a mode in which a high frequency signal is supplied by gold wire bonding after an InP element is mounted on a temperature controller (temperature controller: TEC, hereinafter referred to as TEC).

### CITATION LIST

### Patent Literature

[PTL 1] Japanese Patent Application Publication No. 2018-189697

[PTL 2] WO 2016/194369

### SUMMARY OF INVENTION

### Technical Problem

However, in a device in which a modulation element is mounted by a flip chip, there is a problem of warpage of the TEC. That is, the TEC is configured with Peltier elements having a heat absorbing surface and a heat radiating surface, and the TEC may be warped due to a difference in thermal expansion of a material corresponding to a temperature difference between the heat absorbing surface and the heat radiating surface. In this case, the TEC is cured and fixed to the optical modulation element by using a thermosetting fixing material, and when the warpage occurs, the stress thereof is directly applied to the optical modulation element. As a result, the stress causes poor adhesion of the connection portion of the optical modulation element with the flip chip (ball bump), and there is a possibility of causing electrical disconnection.

An object of the present invention is to provide a light modulation device capable of preventing deformation of an optical modulation element due to warpage of a TEC.

### Solution to Problem

In order to achieve the above object, a first aspect of a light modulation device of the present invention includes an optical modulation element that is flip-chip connected on a high-frequency wiring substrate, a temperature controller that controls a temperature of the optical modulation element, a heat spreader that is connected to the temperature controller, and a deformable adhesive layer that connects the temperature controller and the optical modulation element on a surface different from the heat spreader and is deformable in response to stress caused by deformation of the temperature controller.

The deformable adhesive layer may be a silicone resin.

### Advantageous Effects of Invention

According to the above-described aspect, it is possible to prevent deformation of the optical modulation element due to warpage of the TEC in the light modulation device.

### BRIEF DESCRIPTION OF DRAWINGS

FIG. 1 is a diagram illustrating a cross-sectional view of an optical modulation device according to an embodiment of the present invention.

FIG. 2 is a perspective view of an optical modulation device according to an embodiment of the present invention.

FIG. 3 is a diagram illustrating a cross-sectional view of an optical modulation device according to a comparative example.

### DESCRIPTION OF EMBODIMENTS

Hereinafter, embodiments of the present invention will be described with reference to the accompanying drawings. In the drawings, the same reference numerals are given to portions having the same functions. However that the present invention is not limited to the details describing the following embodiments, and it is obvious for a person skilled in the art that various modifications can be made to of the configurations and details without departing from the spirit of the invention disclosed in the present specification and the like.

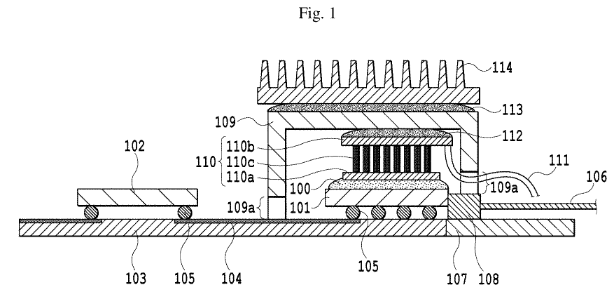

FIG. 1 is a cross-sectional view illustrating a configuration of an optical modulation device according to an embodiment of the present invention.

An optical modulation element 101 and a driver IC 102 are provided on a high-frequency wiring (circuit) substrate 103 through flip-chip mounting. That is, the optical modulation element 101 and the driver IC 102 are connected to the high-frequency wiring substrate 103 through balls 105 constituting flip-chip mounting, respectively. The balls 105 are connected to each other via high-frequency wiring 104.

By using, for example, an n-i-p-n type optical modulation element having a high-speed and wide-band property as described in PTL 2, the optical modulation element 101 can be expected to have a band improvement effect obtained when changing from wire bonding to flip-chip mounting.

The high-frequency wiring substrate 103 is formed by using an alumina material excellent in workability of a wiring pattern. The material is not limited thereto, and for example, an aluminum nitride material or an organic material having a small difference in thermal expansion coefficient from InP, or a quartz material of a low dielectric material or a mixture of ceramic and glass (for example, a low temperature co-fired ceramic: LTCC) can be used.

An optical fiber 106 is connected to one end of the optical modulation element 101 through a fiber block 108. That is, the fiber block 108 on the substrate 107 is interposed. By adopting this configuration, the mounting process can be further simplified. As a result, optical input/output end faces of the optical modulation element can be directly connected (butt coupling) by the fiber block 108 on the substrate 107.

Although other optical coupling forms by spatial lens coupling or the like are possible, in this case, it is desirable that the optical mounting is performed after the mounting of a heat spreader (heat radiation support substrate) 109 described later. This is because there is a possibility that optical coupling with the lens is deviated when some tension (stress) is applied to the optical modulation element 101 when mounting the heat spreader 109.

A TEC (Temperature Controller) 110 is disposed between the optical modulation element 101 and the heat spreader 109. The TEC 110 includes a heat absorbing surface 110a, a heat radiating surface 110b, and a Peltier element 110c provided therebetween. The heat absorbing surface 110a of the TEC 110 is bonded to the optical modulation element 101 by a non-curable paste 100 described later. On the other hand, the heat radiating surface 110b of the TEC 110 is bonded to the heat spreader 109 by a thermosetting fixing material (deformable adhesive layer) 112 which is also described later.

In the present embodiment, a silicone resin is used as the material of the non-curable paste 100. On the other hand, a silver paste material is used as the material of the thermosetting fixing material 112, but it can be used as a solder.

Regarding the configuration of the TEC 110, heat generated by the operation of the optical modulation element 101 is transmitted to the heat absorbing surface 110a of the Peltier element 110c via the non-curable paste 100 having a predetermined thermal conductivity, whereas the heat of the heat radiating surface 110b of the Peltier element 110c is transmitted to the heat spreader 109 through the thermosetting fixing material 112 having a predetermined thermal conductivity. With these configurations, the temperature of the optical modulation element 101 can be controlled by a current applied to the Peltier element 110c via a lead wire 111.

The method of manufacturing an optical modulation device described above can obtain the optical modulation device of the present embodiment that includes the optical modulation element 101 that is flip-chip connected on the high-frequency wiring substrate 103, the temperature controller 110 that controls the temperature of the optical modulation element 101, the heat spreader 109 that is connected to the temperature controller 110, and the thermosetting fixing material (deformable adhesive layer) 112 that connects the temperature controller 110 and the optical modulation element 101 on a surface different from the heat spreader 109 and is deformable in response to stress caused by deformation of the temperature controller 110.

The height of a hole of the heat spreader 109 is designed so that a hole of approximately 10 to 50 μm is formed between the heat absorbing surface 110a of the TEC 110 and the surface of the optical modulation element 101 at the time of mounting a thermal resistance. By providing the heat spreader 109 in this manner, a gap can be formed and the height thereof can be controlled.

In general, the warpage of the TEC 110 described above is such that depending on whether the outside air temperature is higher or lower than the driving temperature of the optical modulation element 101, the warping direction of the TEC 110 is different. In the present embodiment, the drive temperature is set to 50° C., but in any case, the present embodiment, as will be described later, may be configured such that the warpage of the TEC 110 does not act as stress on the optical modulation element 101 regardless of the direction of the warpage.

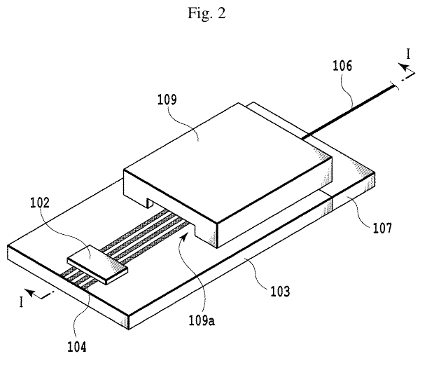

As depicted in FIG. 2, a notch 109a is provided in the heat spreader 109 in order to prevent interference between the high-frequency wiring 104 and the optical fiber 106 and the heat spreader 109. If the notch 109a is not provided, the high-frequency wiring (line) 104 may be affected. In the present embodiment, since the cross section of the heat spreader 109 is in an inverted C-shape and the warpage of the heat spreader 109 is also a concern, the notch 109a is formed so as to have a minimal interference on the high-frequency wiring 104 and on the mounting of the optical fiber 106.

Referring again to FIG. 1, a heat radiating fin (heat radiating plate) 114 is attached to the heat spreader 109 through a heat conductive paste 113. Heat dissipation from the heat spreader 109 can be facilitated by a configuration in which the heat conductive paste 113 is provided on the heat spreader 109 and the heat radiating fin (heat radiating plate) 114 is provided on the heat conductive paste 113. The lead wire 111 is connected to the TEC 110 so as to supply power to the TEC 110 mounted by face-down (refer to the case where the surface side of the optical modulation element 101 being a semiconductor layer laminated on the high-frequency wiring substrate 103 is bonded). The lead wire 111 extends to the outside of the region of the heat spreader 109 and is connected to an external power supply terminal (not depicted).

According to the optical modulation device of the present embodiment described above, the optical modulation element 101 and the heat absorbing surface 110a of the TEC 110 are bonded and fixed by the non-curable paste 100. The non-curable paste 100 is formed of a silicone resin, and has a function of bonding the optical modulation element 101 and the heat absorbing surface 110a of the TEC 110, and absorbing the external stress by deforming against said stress. As a result, even if warpage occurs in the TEC, the warpage is absorbed by the deformation of the non-curable paste 100, whereby stress due to the warpage does not reach the optical modulation element 101. Thus, the deformation of the optical modulation element 101 can be prevented or its deformation amount can be set within an allowable range. In the present embodiment, even if the optical modulation element 101 is deformed, the aberration (error) due to the deformation can be suppressed within 10%. As a result, the occurrence of a connection failure with a flip-chip connection portion (ball connection) and the possibility of inducing electric disconnection can be prevented beforehand.

Here, the non-curable paste 100 may be made of any material as long as it has a function of absorbing the external stress by being deformed against said stress (deformed adhesive layer). The degree of the deformation of the material can be expressed by the viscosity of the material such that the material is more easily deformed as the viscosity is lower. When the material of the non-curable paste 100 is thus defined by viscosity, in the present embodiment, for example, it can be expressed in comparison with the viscosity of the thermosetting fixing material 112 bonding the heat radiating surface 110b of the TEC 110 and the heat spreader 109, in which case the viscosity of the non-curable paste 100 can be specified to be lower than that of the thermosetting fixing material 112. That is, in the present embodiment, the TEC 110 (the heat radiating surface 110b thereof) is fixed to the heat spreader 109 by the thermosetting fixing material 112 so that the thermosetting fixing material 112 is not substantially deformed, and the TEC 110 (the heat absorbing surface 110a thereof) is bonded to the optical modulation element 101 by the non-curable paste 100 so that the non-curable paste 100 can be deformed against stress.

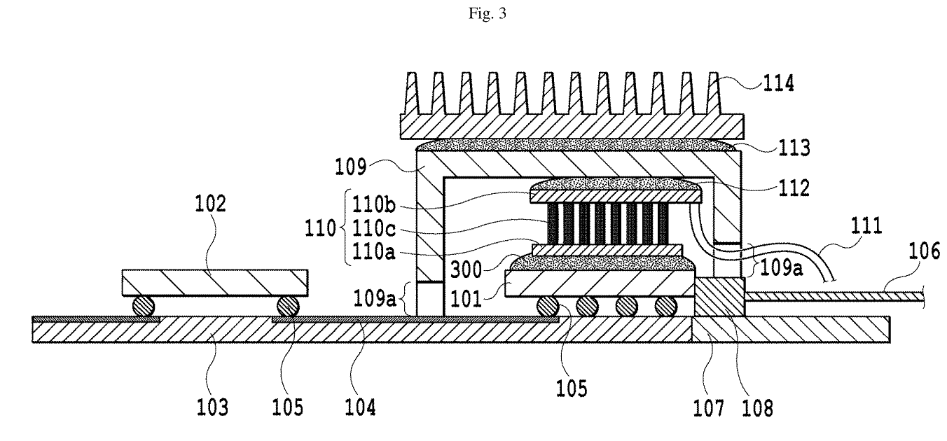

FIG. 3 illustrates an optical modulation device according to a comparative example. In the comparative example depicted in this drawing, the optical modulation device of this example differs from the optical modulation device of the present embodiment depicted in FIG. 1 in that a thermosetting fixing material 300 is used between the optical modulation element 101 and the heat absorbing surface 110a of the TEC 110. Thus, in the comparative example, when the TEC 110 is warped, since the thermosetting fixing material 300, which is not substantially deformed by the stress caused by the warpage, is interposed between the TEC 110 and the optical modulation element 101, the stress of the warpage is exerted on the optical modulation element 101. As a result, there is a risk of inducing breakage or the like of the flip chip (balls 104 bumps) connection portion on the surface of the optical modulation element 101.

1. A light modulation device, comprising:
an optical modulation element being flip-chip connected on a high-frequency wiring substrate;
a temperature controller configured to control a temperature of the optical modulation element;
a heat spreader being connected to the temperature controller; and
a deformable adhesive layer configured to connect the temperature controller and the optical modulation element on a surface different from the heat spreader, the deformable adhesive layer being deformable in response to stress caused by deformation of the temperature controller.

2. The light modulation device according to claim 1, wherein the temperature controller and the heat spreader are bonded by an adhesive layer, and
a viscosity of the deformable adhesive layer is lower than a viscosity of the adhesive layer between the temperature controller and the heat spreader.

3. The light modulation device according to claim 1, wherein a spatial distance between the optical modulation element and a heat absorbing surface of the temperature controller is at least 10 μm or more.

4. The light modulation device according to claim 2, wherein the adhesive layer inserted between the temperature controller, and the heat spreader is thermally cured and fixed.

5. The light modulation device according to claim 1, wherein a silicone resin is used for the deformable adhesive layer inserted between the temperature controller and the optical modulation element.

6. The light modulation device according to claim 1, wherein on the high-frequency wiring substrate, a driver IC chip is flip-chip connected.

7. The light modulation device according to claim 1, wherein a power supply terminal of the temperature controller is connected by a lead wire, and
power is supplied to the lead wire outside the heat spreader.

8. The light modulation device according to claim 1, wherein a thin-film resistance pattern is provided on the high-frequency wiring substrate, the thin-film resistance pattern being used as a termination resistor of a high-frequency signal propagated on the optical modulation element.
